(19) United States
(12) Patent Application Publication
(10) Pub. No.: US 2025/0286234 A1
(43) Pub. Date: Sep. 11, 2025

(54) BATTERY DEVICE

(71) Applicant: HONDA MOTOR CO., LTD., Tokyo (JP)

(72) Inventor: Keisuke Yomogizawa, Tokyo (JP)

(73) Assignee: HONDA MOTOR CO., LTD., Tokyo (JP)

(21) Appl. No.: 19/055,512

(22) Filed: Feb. 18, 2025

(30) Foreign Application Priority Data
Mar. 9, 2024 (CN) 202410268234.8

(51) Int. Cl. H01M 50/507; H01M 50/244; H01M 50/249; H01M 50/271

(52) U.S. Cl. CPC H01M 50/507; H01M 50/244; H01M 50/249; H01M 50/271; H01M 2220/20

(57) ABSTRACT

A battery device includes: battery modules; and a housing configured to accommodate the battery modules. The housing configured to accommodate a pair of strip-shaped bus bars and a member retaining the pair of bus bars, the member includes a retainer with one side open and having a U-shaped cross section and first and a second cover portions that are rotatably disposed on the retainer, a first bus bar of the pair of bus bars is accommodated between the retainer and the first cover portion, a second bus bar of the pair of bus bars is accommodated between the first cover portion and the second cover portion, and a pressed portion is formed on the first cover portion, and is formed to be pressed and cause the first cover portion to rotate when the first bus bar is placed between the retainer and the first cover portion.

### CROSS-REFERENCE TO RELATED APPLICATIONS

This application is based on and claims priority under 35 USC 119 from Chinese Patent Application No. 20/241,0268234.8 filed on Mar. 9, 2024, the contents of which are incorporated herein by reference.

### TECHNICAL FIELD

The disclosure relates to a battery device loaded in an electric vehicle and the like.

### BACKGROUND

In recent years, with increasing attention to environmental protection and sustainable development, secondary batteries, particularly applications in the field of electric vehicles, have attracted great attention. These batteries are not only affordable and reliable, but also must be sustainable and advanced to ensure efficient utilization of energy. The popularity of electric vehicles is becoming an important trend in the development of modern transportation, and its core relies on an efficient and long-life secondary battery technology. The development and improvement of this technology is critical for reducing dependence on fossil fuels, lowering greenhouse gas emissions, and promoting energy transfer. Therefore, research and development of the secondary batteries are not only important aspects of technical innovation but also a key to a cleaner and greener transportation system.

In the electric vehicles, a battery device (also referred to as a “battery pack”) is one of core components responsible for powering the vehicle. The battery pack consists of the plurality of secondary battery modules accommodated in a battery pack housing. Integration and management of the battery modules through the battery pack is important for improving the range of the electric vehicle, reducing charging time and improving overall energy efficiency. See Japanese Patent Application Laid-Open Publication No. 2021125430A.

A battery pack in an electric vehicle is an important component and is formed by combining a plurality of battery modules, and the battery modules are connected to each other through bus bars to form a unified energy supply system.

A main function of these bus bars is to connect battery cells and connect the battery pack to a main switch and a junction box of the vehicle. The arrangement of the bus bars needs to be considered in the design of battery packs since a layout thereof affects an overall size and an efficiency of the battery pack. If the arrangement of the bus bars is unreasonable, it will cause the battery pack to increase in volume and occupy too much cabin space, and may affect the performance and reliability of the battery pack.

Due to a limited interior space of the vehicle, it is necessary to find a suitable balance between sufficient battery capacity and the interior space of the vehicle. In practical applications, in order to fix and manage the bus bars in a narrow battery pack housing space, fixing members such as clips are usually used. In the process of manufacturing and assembling the battery pack, simplifying the number of the fixing members not only reduces material costs, but also helps reduce assembly complexity, thereby improving production efficiency and reducing overall costs.

The present disclosure provides a battery device capable of properly disposing bus bars and reducing the number of fixing members.

### SUMMARY

According to a first aspect of the present disclosure, there is provided a battery device for an electric vehicle including:
a plurality of battery modules; and
a housing configured to accommodate the plurality of battery modules, in which
the housing is configured to accommodate a pair of strip-shaped bus bars and a retaining member retaining the pair of bus bars,
the retaining member includes
   a retaining portion with one side open and having a U-shaped cross section, and
   a first cover portion and a second cover portion that are rotatably disposed on the retaining portion,
a first bus bar of the pair of bus bars is accommodated between the retaining portion and the first cover portion,
a second bus bar of the pair of bus bars is accommodated between the first cover portion and the second cover portion, and
a pressed portion is formed on the first cover portion, and is formed to be pressed and cause the first cover portion to rotate when the first bus bar is placed between the retaining portion and the first cover portion.

According to a second aspect of the present disclosure, there is provided a method for assembling bus bars in a battery device for an electric vehicle using a retaining member, in which
the battery device includes a plurality of battery modules and a housing configured to accommodate the plurality of battery modules,
the housing is configured to accommodate the pair of strip-shaped bus bars and the retaining member retaining the pair of bus bars,
the retaining member includes a retaining portion with one side open and having a U-shaped cross section, and a first cover portion and a second cover portion that are rotatably disposed on the retaining portion,
a pressed portion is formed on the first cover portion, and
the method includes:
pressing a first bus bar of the pair of bus bars toward the pressed portion to rotate the first cover portion, and accommodating the first bus bar between the retaining portion and the first cover portion;
disposing a second bus bar of the pair of bus bars on the rotated first cover portion; and
rotating the second cover portion to accommodate the second bus bar between the first cover portion and the second cover portion.

According to the battery device in the present disclosure, the two bus bars can be fixed by using one retaining member, the requirement of two or more independent retaining members in the past is eliminated, the number of parts is reduced, and operation steps of installing the bus bars are simplified. Moreover, a space can be efficiently utilized in the compact arrangement of the battery modules, and a space layout in the battery pack can optimized.

### BRIEF DESCRIPTION OF DRAWINGS

Exemplary embodiment(s) of the present disclosure will be described in detail based on the following figures, wherein:

FIG. 1 is a plan view of a battery pack according to an embodiment of the present disclosure;

FIG. 2 is a perspective view of a retaining member according to the first embodiment of the present disclosure;

FIG. 3 is a schematic side view of the retaining member in an open state according to the first embodiment of the present disclosure;

FIG. 4 is a schematic side view of the retaining member in a closed state according to the first embodiment of the present disclosure;

FIGS. 5A to 5D are schematic diagrams showing steps of installing bus bars in the retaining member according to the first embodiment of the present disclosure;

FIG. 6 is a perspective view of a retaining member according to a second embodiment of the present disclosure;

FIG. 7 is a schematic side view of the retaining member in an open state according to the second embodiment of the present disclosure;

FIG. 8 is a schematic side view of the retaining member in a closed state according to the second embodiment of the present disclosure;

FIGS. 9A to 9D are schematic diagrams showing steps of installing bus bars in the retaining member according to the second embodiment of the present disclosure;

FIG. 10 is a perspective view of a retaining member according to a third embodiment of the present disclosure;

FIG. 11 is a schematic side view of the retaining member in an open state according to the third embodiment of the present disclosure;

FIG. 12 is a schematic side view of the retaining member in a closed state according to the third embodiment of the present disclosure; and

FIGS. 13A to 13D are schematic diagrams showing steps of installing bus bars in the retaining member according to the third embodiment of the present disclosure.

### DESCRIPTION OF EMBODIMENTS

Hereinafter, embodiments of the present disclosure will be described with reference to the accompanying drawings. The same structures in the drawings are denoted by the same reference numerals.

### First Embodiment

### Battery Pack

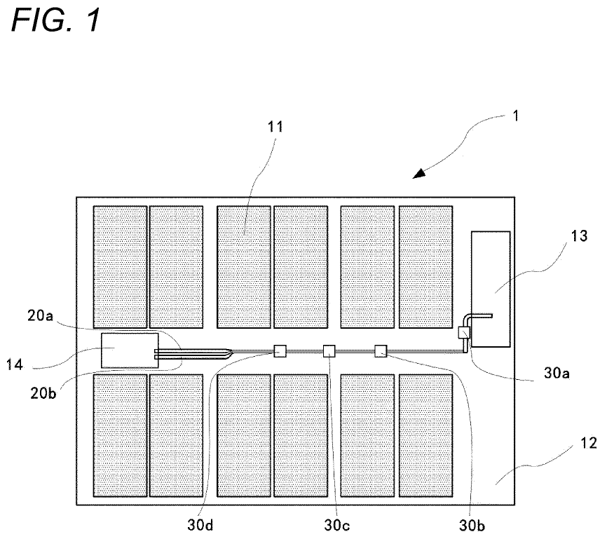

FIG. 1 is a plan view of a battery pack according to an embodiment of the present disclosure, in which shaded boxes represent battery modules 11. As shown in FIG. 1, a battery pack 1 of the present disclosure includes the plurality of battery modules 11 (twelve in the present embodiment) and a housing 12 accommodating these battery modules 11, and can be mounted in an electric vehicle such as a pure electric vehicle, a hybrid electric vehicle, a fuel cell electric vehicle and the like. Each battery module 11 is formed by stacking a plurality of battery cells in a left-right direction.

In the housing 12, the battery modules 11 are arranged in two rows, each row including six battery modules. One end of the housing 12 is provided with a first junction box 13, and the other end of the housing 12 is provided with a second junction box 14. The first junction box 13 and the second junction box 14 are used for supplying electric power from the battery modules 11 to a motor of the vehicle, and supplying electric power received from the motor to the battery 11. The housing 12 containing the battery modules 11, the first junction box 13, and the second junction box 14 is closed by a housing cover (not shown).

The first junction box 13 and the second junction box 14 are electrically connected through bus bars 20. The bus bar is usually made of a highly conductive material and is covered with insulating material on an outer periphery thereof. The bus bar is a connecting member inside the battery pack in the electric vehicle, a main function is to collect and distribute current, and in a traveling process of the electric vehicle, a large amount of current is required to drive the motor, and these currents are provided by the battery modules and transmitted through the bus bars. When the driver depresses a gas pedal or a brake pedal, the battery pack outputs or recovers the current according to the demand, and the bus bars ensure that these currents can quickly and accurately reach a designated location.

In the present embodiment, the first junction box 13 and the second junction box 14 are electrically connected through two bus bars 20a and 20b (also collectively referred to as “bus bars 20” in the specification). The bus bars 20a and 20b both have a strip shape, and have substantially the same thickness (a shortest side among three sides of the strip-shaped bus bar) and the same width (a second shortest side among the three sides of the strip-shaped bus bar). One end of each of the bus bars 20a and 20b is connected to a junction terminal of the first junction box 13 and extends laterally from the first junction box 13, and the bus bars 20a and 20b are stacked up and down in a horizontal state. Here, the “horizontal state” and the “laterally extending” of the bus bars refer to that a length direction and a width direction of the strip-shaped bus bars 20 are substantially in a plane parallel to a bottom surface of the housing 12 (a paper surface direction of FIG. 1), and a thickness direction is generally along a direction perpendicular to the bottom surface of the housing 12 (a direction perpendicular to the paper surface in FIG. 1). The two bus bars 20a and 20b stacked up and down in the horizontal state are manually bent and then connected to the second junction box 14 through the battery modules to enable electrical connection between the first junction box 13 and the second junction box 14. The layout of the bus bars includes a step of bending the bus bars 20a and 20b that are stacked up and down in the horizontal state directly downward and then along a length direction, so that the broadening of the bus bars 20a and 20b are widened in a vertical direction, that is, the two bus bars 20a and 20b extend longitudinally side by side in an upright state. Here, the “upright state” and “longitudinally extending” refer to that the length direction and the thickness direction of the strip-shaped bus bars 20 are substantially in a plane parallel to the bottom surface of the housing 12 (the paper surface direction of FIG. 1), and the width direction is generally along the direction perpendicular to the bottom surface of the housing 12 (the direction perpendicular to the paper surface in FIG. 1). In this way, the two bus bars 20a and 20b can be effectively disposed side by side between the closely arranged battery modules to adapt to space limitation inside the battery pack and optimize space utilization in the battery pack.

In order to reduce displacement of the bus bars 20 caused by vibration or movement, improve the stability and reliability of a battery pack device, as shown in FIG. 1, a plurality of retaining member 30a to 30d for fixing the bus bars 20 are mounted on the housing 12. One end of each of the bus bars 20a and 20b is connected to the junction terminal of the first junction box 13 and extends laterally from the first junction box 13, and the bus bars 20a and 20b are stacked up and down in the horizontal state, and in the present embodiment, the bus bar 20a is located above the bus bar 20b. The bus bars 20a and 20b stacked up and down in the horizontal state are fixed in the retaining member 30a, then pass through the battery modules side by side in the upright state after being bent, are sequentially fixed in the retaining members 30b, 30c, and 30d, and are finally connected to the second junction box 14.

The retaining member 30 of the present disclosure can retain the two bus bars 20a and 20b with one retaining member 30, and thus the number of retaining members 30 is reduced. The structure of the retaining member 30 in the housing 12 of the battery pack 1 and retention of the bus bars 20a and 20b by the retaining member 30 will be described below with reference to the accompanying drawings. In the drawings, the front of the retaining member is denoted as Fr, the rear is denoted as Rr, a left side is denoted as L, a right side is denoted as R, an upper side is denoted as U, and a lower side is denoted as D. It should be noted that the front, rear, left, right, upper, and lower sides of the retaining member have nothing to do with the front, rear, left, right, upper, and lower sides of the battery pack on which the retaining member is mounted and the vehicle.

### Retaining Member

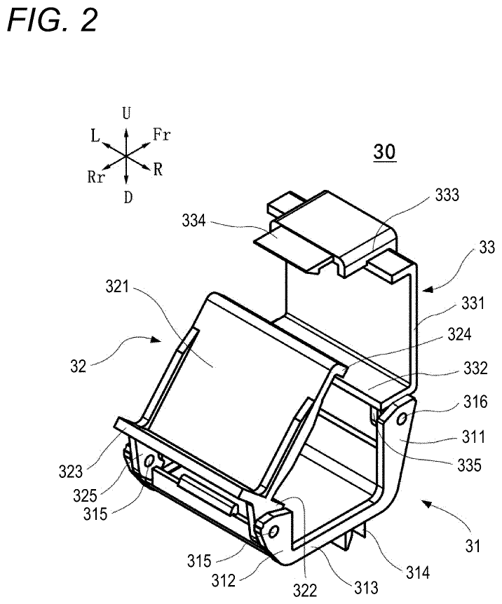

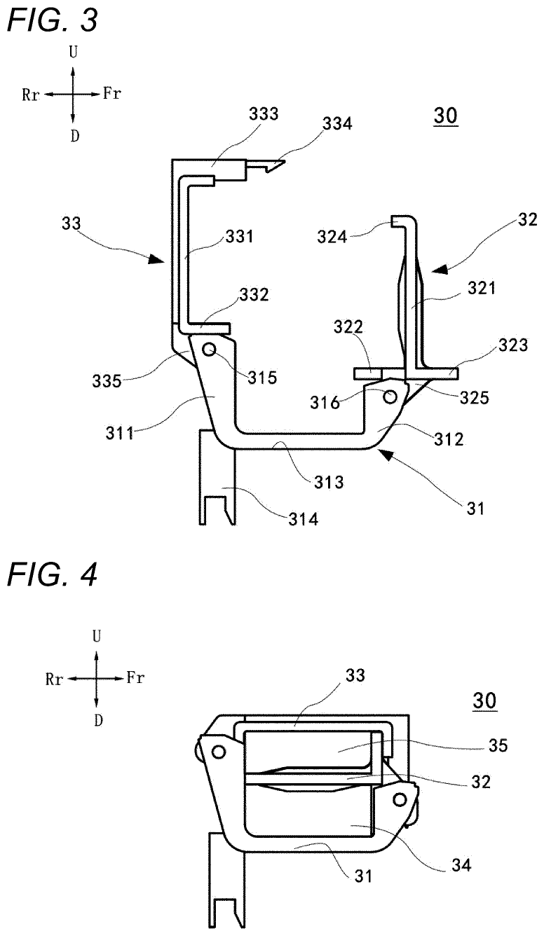

FIG. 2 is a perspective view of the retaining member 30 according to the first embodiment of the present disclosure, FIG. 3 is a schematic side view of the retaining member 30 in an open state according to the first embodiment of the present disclosure, and FIG. 4 is a schematic side view of the retaining member 30 in a closed state according to the first embodiment of the present disclosure. As shown in the drawings, the retaining member 30 includes a retaining portion 31 having a U-shaped cross section, and a first cover portion 32 and a second cover portion 33 rotatably fixed to the retaining portion 31.

Specifically, in the retaining member 30 of the present embodiment, the retaining portion 31 is composed of a first sidewall portion 311, a second sidewall portion 312, a bottom surface portion 313 connecting them, and a mounting portion 314 located at the end where the first sidewall portion 311 of the bottom surface portion 313 is located and extending downward from the bottom surface portion 313. The first sidewall portion 311, the second sidewall portion 312, the bottom surface portion 313 and the mounting portion 314 are integrally formed and form a flat-bottomed U shape opened upward in a side view, and the height of the first sidewall portion 311 is greater than the height of the second sidewall portion 312. Two rotating shafts 316 are formed on left and right sides of an upper end of the first sidewall portion 311, extend from a left end and a right end respectively to the center by a predetermined length, and are used for cooperating with pivot hole portions 335 of the second cover portion 33 to be described below to mount the second cover portion 33. Two rotating shafts 315 are formed on left and right sides of an upper end of the second sidewall portion 312, and extend from a left end and a right end respectively to the center by a predetermined length for cooperating with pivot hole portions 325 of the first cover portion 32 to be described below to mount the first cover portion 32. The mounting portion 314 is formed in a socket shape that cooperates with a mounting slot of the housing 12 and configured to mount the retaining member 30 in the housing 12. In order to meet requirements of different installing directions of the retaining member 30, the mounting portion 314 may adopt a rotatable structure or have a socket in two directions perpendicular to each other.

The first cover portion 32 includes a flat plate-shaped cover plate portion 321, an engagement portion 324 extending in a first direction perpendicular to a plane of the cover plate portion 321 and formed at one end of the cover plate portion 321 in a front-rear direction, a pressed portion 322 extending in the first direction and formed at the other end of the cover plate portion 321 in the front-rear direction, a contact wall 323 extending in a second direction opposite to the first direction, and the two pivot hole portions 325 extending obliquely from the cover plate portion and formed on left and right sides of the pressed portion 322. The pivot hole portion 325 is formed with a pivot hole that cooperates with the rotating shaft 315 of the retaining portion 31, and the first cover portion 32 can be rotatably mounted on the retaining portion 31 by sleeve-fitting the pivot hole onto the rotating shaft 315. A front end of the engagement portion 324 is formed with a hook-shaped engaging portion (not shown), and the engaging portion can be engaged with a slot (not shown) formed on an outside of the first sidewall portion 311 of the retaining portion 31, so that the first cover portion 32 can be fixed to the retaining portion 31.

The second cover portion 33 includes a flat plate-shaped cover surface portion 331, and a sidewall portion 332 and an engagement portion 333 extending in a direction perpendicular to the plane of the cover surface portion 331 toward the same side formed at two ends of the cover surface portion 331 in the front-rear direction, respectively. The two pivot hole portions 335 extending obliquely from the sidewall portion 332 are formed at both ends of an outside of the sidewall portion 332, respectively. The pivot hole portion 335 is formed with a pivot hole that cooperates with the rotating shaft 316 of the retaining portion 31, and the second cover portion 33 can be rotatably mounted on the retaining portion 31 by sleeve-fitting the pivot hole onto the rotating shaft 316. The front end of the engagement portion 333 extends to form a hook-shaped engaging portion 334 in a side view, and the engaging portion 334 can be engaged with a slot (not shown) formed on an outside of the second sidewall portion 312 of the retaining portion 31, so that the second cover portion 33 can be fixed to the retaining portion 31.

The first cover portion 32 and the second cover portion 33 are each rotatably mounted on the retaining portion 31, and the retaining portion 31, the first cover portion 32, and the second cover portion 33 are sequentially arranged from bottom to top. As shown in FIG. 4, when the first cover portion 32 is turned to the closed state, that is, the cover plate portion 321 is substantially parallel to the bottom surface portion 313 of the retaining portion 31, surfaces of the cover plate portion 321 and the bottom surface portion 313 of the retaining portion 31 facing each other, an inner side surface of the first sidewall portion 311 of the retaining portion 31, and a surface of the pressed portion 322 of the first cover portion 32 facing the inner side surface constitute a first accommodating space 34 for accommodating one of the bus bars 20a and 20b. When the second cover portion 33 is also turned to the closed state, that is, when the cover surface portion 331 is substantially parallel to the cover plate portion 321 of the first cover portion 32, surfaces of the cover surface portion 331 of the second cover portion 33 and the cover plate portion 321 of the first cover portion 32 facing each other, an inner side surface of the sidewall portion 332 of the second cover portion 33, and a surface of the contact wall 323 of the first cover portion 32 facing the inner side surface constitute the second accommodating space 35 for accommodating the other of the bus bars 20a and 20b.

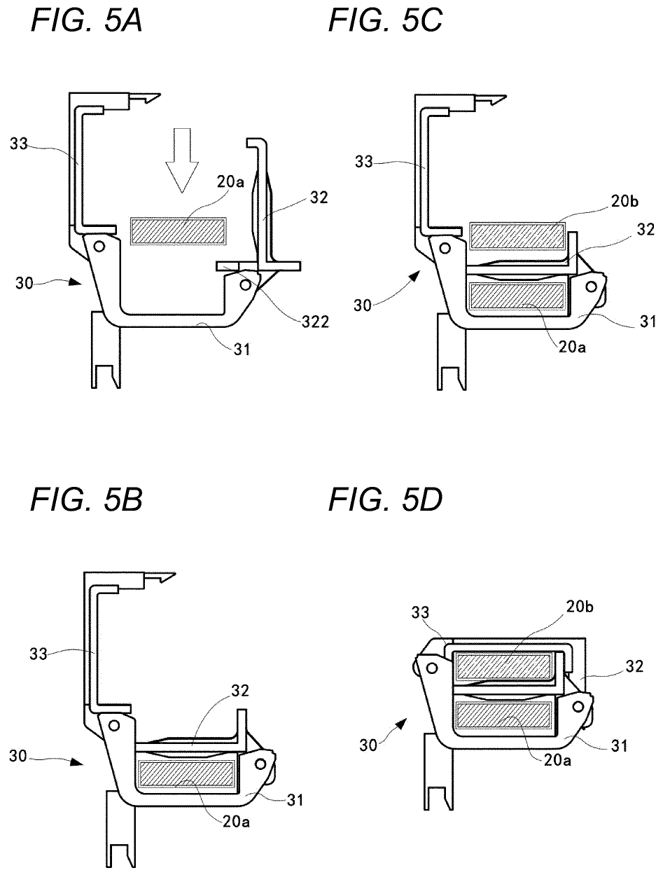

FIGS. 5A to 5D are schematic diagrams showing steps of installing the bus bars in the retaining member according to the first embodiment of the present disclosure. The steps of installing the bus bars 20a and 20b in the retaining member 30 are described in detail below with reference to FIGS. 5A to 5D. It should be noted that the following description is based on the installing of two bus bars 20a and 20b stacked up and down in the retaining member 30 (that is, the retaining member 30a in FIG. 1) as an example. For the installing of two bus bars 20a and 20b disposed side by side in the retaining member 30 (that is, the retaining members 30b to 30d in FIG. 1), it is sufficient to rotate each member and the operating direction by 90 degrees in the following steps.

First, as shown in FIG. 5A, in the retaining member 30, the first cover portion 32 and the second cover portion 33 are opened. At this stage, the installer starts to install a first bus bar (taking the bus bar 20a as an example). The installer presses the bus bar 20a into the retaining member 30 from above, as indicated by the arrow. During this process, the bus bar 20a comes into contact with and pushes the pressed portion 322 of the first cover portion 32 when pressed downward, which causes the first cover portion 32 to rotate downward about an axis (the rotating shaft 315) and enter a closed state, as shown in FIG. 5B. As the bus bar 20a continues moving until the bus bar 20a comes into contact with the bottom surface portion 313 of the retaining portion 31, the pressed portion 322 of the first cover portion 32 is pushed into contact with the inner side surface of the first sidewall portion 311 of the retaining portion 31. At this time, the first cover portion 32 is completely closed, and the bus bar 20a is stably accommodated in the first accommodating space 34. Then, the installer presses the first cover portion 32 downward to engage the engaging portion formed at the front end of the engagement portion 324 with the slot formed on the outside of the first sidewall portion 311 of the retaining portion 31, thereby fixing the first cover portion 32 to the retaining portion 31 to complete installation of the bus bar 20a.

Then, as shown in FIG. 5C, the installer places the second bus bar (bus bar 20b) from above into the second accommodating space 35 in a similar way. In the last step, as shown in FIG. 5D, the installer pushes the second cover portion 33 to the closed state and presses the second cover portion 33 downward, so that the engaging portion 334 of the second cover portion 33 is engaged with the slot formed on the outside of the second sidewall portion 312 of the retaining portion 31, thereby fixing the second cover portion 33 to the retaining portion 31, and completing the installation of the bus bar 20b.

### Assembly Steps

Steps of assembling the retaining member 30 and the bus bars 20a and 20b within the housing 12 of the battery pack 1 are described below.

After the battery cells and the first and second junction boxes are mounted in the housing 12, the retaining member 30 is mounted at a predetermined position. As shown in FIG. 1, four retaining members 30a to 30d are provided as an example of the present disclosure, the retaining member 30a is for retaining the bus bars 20a and 20b stacked up and down in the horizontal state, and the retaining members 30b to 30d retain the bus bars 20a and 20b disposed side by side in the upright state.

Then, the first bus bar (taking the bus bar 20a as an example) is firstly installed, and two ends of the bus bar 20a are connected to the first and second junction boxes, respectively. Then, the bus bar 20a is sequentially installed into the retaining members 30a to 30d, that is, the bus bar 20a is properly positioned in the first accommodating space 34, and the first cover portion 32 falls to be substantially parallel to the bottom surface portion 313 of the retaining portion 31. Finally, two terminals of the bus bar 20a are fixed by bolts.

Next, a second bus bar (bus bar 20b) is installed, two ends of the bus bar 20b are connected to the first and second junction boxes, respectively, and then the bus bar 20b is sequentially installed into the retaining members 30a to 30d, that is, the bus bar 20b is properly located in the second accommodating space 35, and finally the two terminals of the bus bar 20b are fixed by bolts.

Finally, the second cover portion of each of the retaining members 30a to 30d is closed and gently pressed to engage the engagement portion of the upper cover with the retaining portion to complete the installation.

In this way, compared with the a method in the related art, the retaining member 30 in the first embodiment of the present disclosure allows the two bus bars 20a and 20b to be fixed in the same retaining member, so that the need for more than two independent retaining members is eliminated. By allowing the two bus bars 20a and 20b to be stacked up and down or disposed side by side, space can be efficiently utilized in the compact arrangement of the battery modules, and a space layout in the battery pack can be optimized. Moreover, by adopting the design of the pressed portion 322, the retaining member 30 automatically pushes the first cover portion 32 to rotate and close when installing the first bus bar. This design not only reduces the number of parts, but also simplifies the operation steps of installing the bus bars. In this way, the present disclosure not only improves assembly efficiency, but also enhances overall structural stability and a space utilization rate of the battery pack.

### Second Embodiment

### Retaining Member

A retaining member 30A according to a second embodiment of the present disclosure will be described below with reference to the drawings. In the following description, description of the same components as those of the retaining member 30 of the first embodiment will be omitted or simplified. In the retaining member 30 of the first embodiment, the first cover portion 32 and the second cover portion 33 are respectively rotatably fixed to the first sidewall portion 311 and the second sidewall portion 312 of the retaining portion 31, respectively, while in the retaining member 30A of the second embodiment, the first cover portion and the second cover portion are rotatably fixed to the same sidewall of the retaining portion.

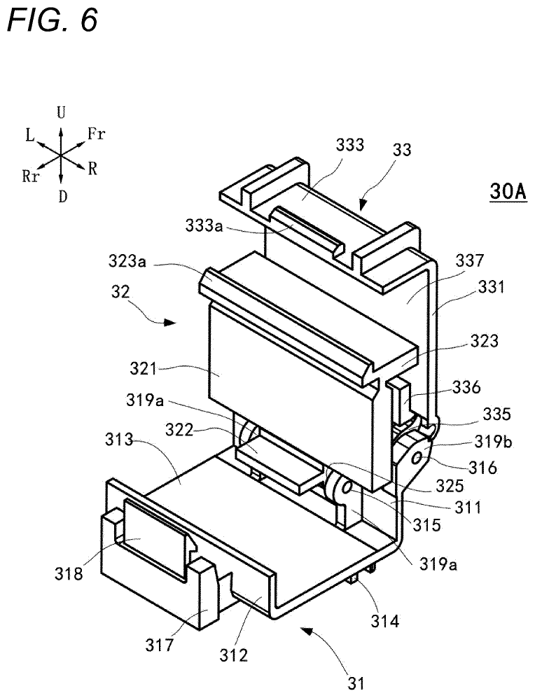

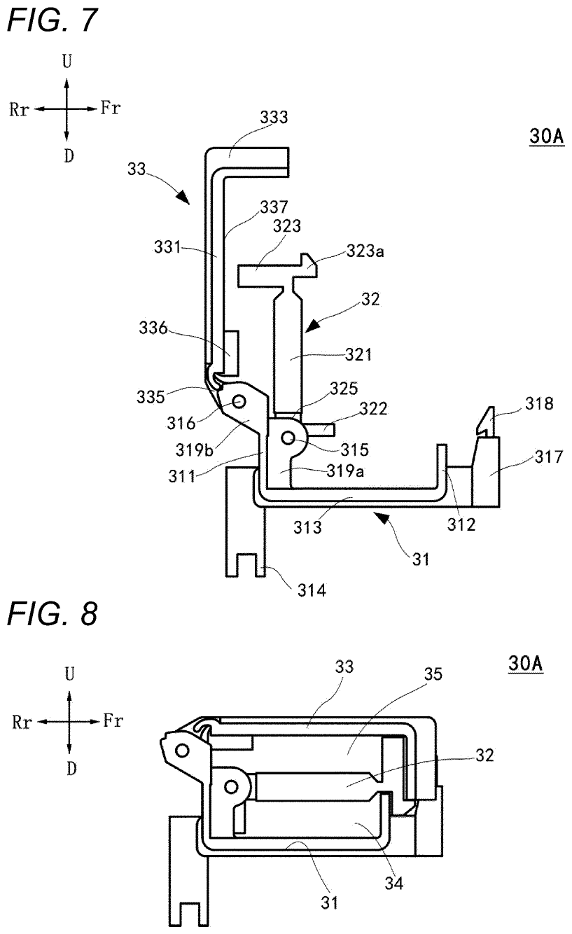

FIG. 6 is a perspective view of the retaining member 30A according to the second embodiment, FIG. 7 is a schematic side view of the retaining member 30A in an open state according to the second embodiment of the present disclosure, and FIG. 8 is a schematic side view of the retaining member 30A in a closed state according to the second embodiment. As shown in the drawings, the retaining member 30A includes the retaining portion 31 having a U-shaped cross section, and the first cover portion 32 and the second cover portion 33 rotatably fixed to the retaining portion 31.

Specifically, in the retaining member 30A of the present embodiment, the retaining portion 31 is composed of the first sidewall portion 311, the second sidewall portion 312, the bottom surface portion 313 connecting them, and the mounting portion 314 located at the end where the first sidewall portion 311 of the bottom surface portion 313 is located and extending downward from the bottom surface portion 313. The first sidewall portion 311, the second sidewall portion 312, the bottom surface portion 313 and the mounting portion 314 are integrally formed and form a flat-bottomed U shape opened upward in a side view. The first sidewall portion 311 is formed with two rotating shaft portions 319a extending inward in a direction perpendicular to an inner side surface thereof, and the two rotating shaft portions 319a respectively have rotating shafts 315 extending from two ends to the center by a predetermined length for cooperating with the pivot hole portions 325 of the first cover portion 32 to be described below to mount the first cover portion 32. An upper end of the first sidewall portion 311 is formed with two rotating shaft portions 319b extending outward in a direction perpendicular to an outer side surface thereof, and the two rotating shaft portions 319b respectively have rotating shafts 316 extending from two ends to the center by a predetermined length for cooperating with the pivot hole portions 335 of the second cover portion 33 to be described below to mount the second cover portion 33. As shown in FIG. 7, the rotating shaft portion 319a is formed at a certain distance from a left end and a right end of the first sidewall portion 311, and the rotating shaft portion 319b is formed at a position closer to the left end and the right end than the rotating shaft portion 319a. The outside of the second sidewall portion 312 is formed with an engagement portion 317, and an upper end of the engagement portion 317 extends to form an engaging portion 318 with a hook-shaped side surface in a side view.

The first cover portion 32 includes the flat plate-shaped cover plate portion 321, the pressed portion 322 extending in the first direction perpendicular to the plane of the cover plate portion 321 and formed at one end of the cover plate portion 321 in the front-rear direction, and the contact wall 323 extending in the second direction opposite to the first direction and formed at the other end of the cover plate portion 321 in the front-rear direction. The contact wall 323 extends in the first direction to form a fixing portion 323a protruding outward. The two pivot hole portions 325 extending outward are formed at a left end and a right end of a connection point of the cover plate portion 321 and the pressed portion 322. The pivot hole portion 325 is formed with the pivot hole that cooperates with the rotating shaft 315 of the retaining portion 31, and the first cover portion 32 is rotatably mounted on the retaining portion 31 by sleeve-fitting the pivot hole onto the rotating shaft 315.

The second cover portion 33 includes the flat cover surface portion 331, and the sidewall portion 332 extending in the direction perpendicular to the plane of the cover surface portion 331 and formed at one end of the cover surface portion 331 in the front-rear direction. The other end of the cover surface portion 331 in the front-rear direction is formed with the two pivot hole portions 335 extending obliquely from the cover surface portion 331. The pivot hole portion 335 is formed with a pivot hole that cooperates with the rotating shaft 316 of the retaining portion 31, and the second cover portion 33 is rotatably mounted on the retaining portion 31 by sleeve-fitting the pivot hole onto the rotating shaft 316. An outside of the engagement portion 333 extends outward to form a protruding portion 333a, and the second cover portion 33 can be fixed to the retaining portion 31 by engaging the engaging portion 318 of the retaining portion 31 with the protruding portion 333a. Further, as shown in FIG. 8, at this time, a lower end of the engagement portion 333 abuts on the fixing portion 323a of the first cover portion 32, so that the first cover portion 32 is also fixed. A protrusion 336 protruding from the cover surface portion 331 is formed on an inner side of the pivot hole portion 335. In this way, a groove 337 for accommodating the bus bars 20 is formed between an inner side surface of the cover surface portion 331, the protrusion 336, and the engagement portion 333.

The first cover portion 32 and the second cover portion 33 are each rotatably mounted on the retaining portion 31, and the retaining portion 31, the first cover portion 32, and the second cover portion 33 are sequentially arranged from bottom to top. As shown in FIG. 8, when the first cover portion 32 is turned to the closed state, that is, the cover plate portion 321 is substantially parallel to the bottom surface portion 313 of the retaining portion 31, surfaces of the cover plate portion 321 and the bottom surface portion 313 of the retaining portion 31 facing each other, an inner side surface of the second sidewall portion 312 of the retaining portion 31, and a surface of the pressed portion 322 of the first cover portion 32 facing the inner side surface constitute the first accommodating space 34 for accommodating one of the bus bars 20a and 20b. When the second cover portion 33 is also turned to the closed state, that is, when the cover surface portion 331 is substantially parallel to the cover plate portion 321 of the first cover portion 32, the groove 337 of the second cover portion 33, a surface of the cover plate portion 321 of the first cover portion 32 facing the groove 337, and an inner surface of the contact wall 323 of the first cover portion 32 constitute the second accommodating space 35 for accommodating the other of the bus bars 20a and 20b.

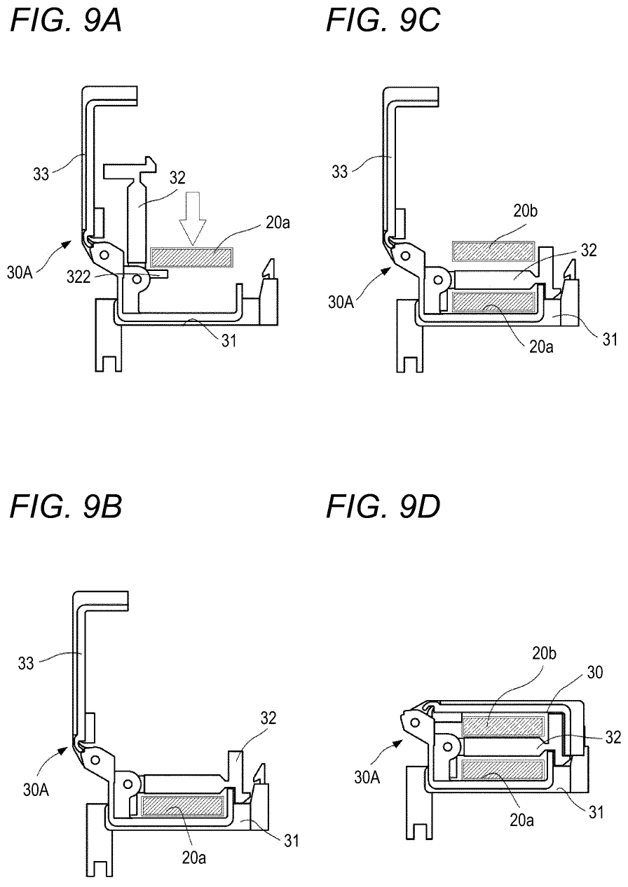

FIGS. 9A to 9D are schematic diagrams showing steps of installing the bus bars in the retaining member according to the second embodiment of the present disclosure. The steps of installing bus bars 20a and 20b in the retaining member 30A are described in detail below with reference to FIGS. 9A to 9D. It should be noted that the following description is based on the installing of two bus bars 20a and 20b stacked up and down in the retaining member 30A as an example. For the installing of two bus bars 20a and 20b disposed side by side in the retaining member 30A, it is sufficient to rotate each member and the operating direction by 90 degrees in the following steps.

As shown in FIG. 9A, in the retaining member 30A, the first cover portion 32 and the second cover portion 33 are opened. At this point, the installer can start an installation process. The installer selects one bus bar (taking the bus bar 20a as an example) and presses it from above into the retaining member 30A, as indicated by an arrow. During this process, the bus bar 20a comes into contact with and pushes the pressed portion 322 of the first cover portion 32 when pressed downward. This action triggers the first cover portion 32 to rotate downward about an axis (rotating shafts 315) into the closed state, as shown in FIG. 9B. As the bus bar 20a continues moving until the bus bar 20a comes into contact with the bottom surface portion 313 of the retaining portion 31, the pressed portion 322 of the first cover portion 32 is pushed into contact with the inner side surface of the first sidewall portion 311 of the retaining portion 31. At this time, the first cover portion 32 is completely closed and covers the bus bar 20a, and the bus bar 20a is stably accommodated in the first accommodating space 34, thereby completing installation of the bus bar 20a.

Then, as shown in FIG. 9C, the installer places the second bus bar (bus bar 20b) from above into the second accommodating space 35 in a similar way. In the final step, as shown in FIG. 9D, the installer pushes the second cover portion 33 so as to rotate the second cover portion 33 to the closed state and presses the second cover portion 33 downward, so that the protruding portion 333a of the second cover portion 33 is engaged with the engaging portion 318 of the retaining portion 31, thereby fixing the second cover portion 33 to the retaining portion 31. At this time, as shown in FIG. 9D, the lower end of the engagement portion 333 of the second cover portion 33 also abuts on the fixing portion 324 of the first cover portion 32, so that the first cover portion 32 is also fixed. In this manner, the installation of the bus bars 20a and 20b is completed.

Similar to the retaining member 30 of the first embodiment, the retaining member 30A in the second embodiment of the present disclosure allows the two bus bars 20a and 20b to be fixed in the same retaining member, so that the need for two or more independent retaining members in the past is eliminated, space can be efficiently utilized in the compact arrangement of the battery modules, and a space layout in the battery pack can be optimized. Moreover, by using the design of the pressed portion 322, the first cover portion 32 is automatically pushed to rotate and close when installing the first bus bar, the number of parts is reduced, and the operation steps of installing the bus bars are also simplified.

In addition, in the second embodiment of the present disclosure, the design of the retaining member 30A allows the installer to engage the retaining portion 31 and fix the first cover portion 32 and the second cover portion 33 together by pressing only the second cover portion 33 without pressing the first cover portion 32 and the second cover portion 33 in sequence. This design further simplifies the operation steps, improves installation efficiency, and makes it easier for the bus bars 20 to be fixed in the retaining member 30A. Moreover, since the first cover portion 32 and the second cover portion 33 are opened toward the same side and an opening degree is relatively large, the operation space is larger and it is easier to visually recognize the bus bars 20 when the bus bars 20 are installed.

In addition, the second cover portion 33 is provided with the protrusion 336 on an inner side surface of the cover surface portion 331, the groove 337 for accommodating the bus bars 20 is formed between the protrusion 336 and the engagement portion 333, the groove 337 and the inner side surface of the contact wall 323 constitute the second accommodating space 35, limits the displacement of the bus bars in the width direction, and thus effectively limits the unnecessary displacement of the bus bars in the width direction. Accordingly, potential damage caused by vibration or movement is reduced, and an additional guarantee is added to the stability and reliability of the whole battery pack device.

### Third Embodiment

### Retaining Member

A retaining member 30B of a third embodiment of the present disclosure will be described below with reference to the drawings.

In the following description, description of the same components as those of the retaining members of the first and second embodiments will be omitted or simplified. In the retaining member 30B of the third embodiment, a first cover portion and a second cover portion are respectively rotatably fixed to the same sidewall of a retaining portion, and the other sidewall of the retaining portion is provided with notches for accommodating the first cover portion.

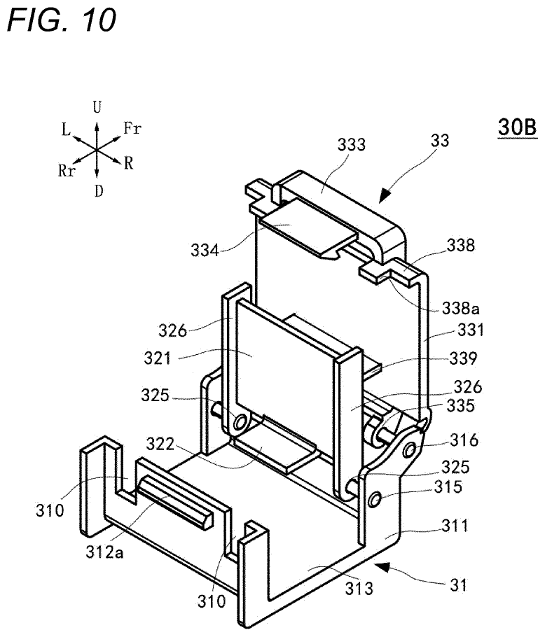

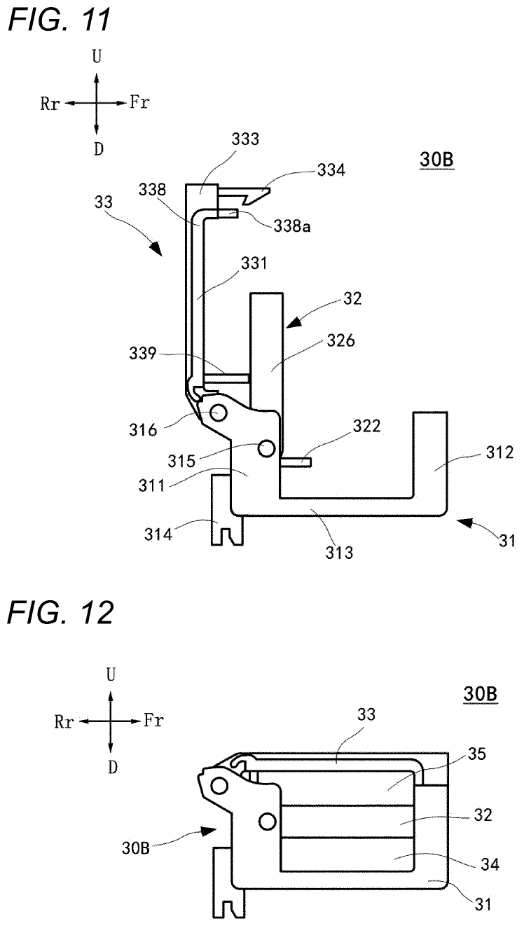

FIG. 10 is a perspective view of the retaining member 30B according to the third embodiment of the present disclosure, FIG. 11 is a schematic side view of the retaining member 30B in an open state according to the third embodiment of the present disclosure, and FIG. 12 is a schematic side view of the retaining member 30B in a closed state according to the third embodiment. As shown in the drawings, the retaining member 30B includes the retaining portion 31 having a U-shaped cross section, and the first cover portion 32 and the second cover portion 33 rotatably fixed to the retaining portion 31.

Specifically, in the retaining member 30B of the present embodiment, the retaining portion 31 is composed of the first sidewall portion 311, the second sidewall portion 312, the bottom surface portion 313 connecting them, and the mounting portion 314 located at the end where the first sidewall portion 311 of the bottom surface portion 313 is located and extending downward from the bottom surface portion 313. The first sidewall portion 311, the second sidewall portion 312, the bottom surface portion 313 and the mounting portion 314 are integrally formed and form a flat-bottomed U shape opened upward in a side view. The first sidewall portion 311 is formed by two parts separated at the left end and the right end, and two rotating shafts 315 extending from a left end and a right end to the center in a direction perpendicular to inner side surfaces thereof are formed at approximately half the height of the two parts, respectively. The two rotating shafts 315 extend to the center for a predetermined length to cooperate with the pivot hole portions 325 of the first cover portion 32 to be described below to mount the first cover portion 32. An upper end of the first sidewall portion 311 is formed with two rotating shafts 316 extending from left and right ends to the center in a direction perpendicular to the inner side surfaces thereof, respectively, and the two rotating shafts 316 extend to the center by a predetermined length to cooperate with the pivot hole portions 335 of the second cover portion 33 to be described below to mount the second cover portion 33. An upper end of the second sidewall portion 312 is formed with two notches 310 for accommodating side portions 326 of the first cover portion 32 to be described below. A protruding portion 312a is formed on an outer side surface of the second sidewall portion 312 between the two notches 310, and the protruding portion 312a is used to be engaged with the engagement portion 334 of the second cover portion 33 to be described below.

The first cover portion 32 includes the flat plate-shaped cover plate portion 321, the pressed portion 322 extending in a direction perpendicular to the plane of the cover plate portion 321 and formed at one end of the cover plate portion 321 in a front-rear direction, and the two side portions 326 extending in the direction perpendicular to the plane of the cover plate portion 321 and formed at the left end and the right end of the cover plate portion 321, respectively. The two pivot hole portions 325 are formed at positions of the two side portions 326 close to the pressed portion 322, respectively, the pivot hole portion 325 cooperates with the rotating shaft 315 of the retaining portion 31, and the first cover portion 32 is rotatably mounted on the retaining portion 31 by sleeve-fitting the pivot hole portion 325 onto the rotating shaft 315.

The second cover portion 33 includes the flat cover surface portion 331, a sidewall portion 338 extending in a first direction perpendicular to a plane of the cover surface portion 331 and formed on one end of the cover surface portion 331 in the front-rear direction, and the two pivot hole portions 335 extending obliquely from the cover surface portion 331 and formed on the other end thereof. The pivot hole portion 335 is formed with a pivot hole that cooperates with the rotating shaft 316 of the retaining portion 31, and the second cover portion 33 is rotatably mounted on the retaining portion 31 by sleeve-fitting the pivot hole onto the rotating shaft 316. At a position slightly closer to the center than the pivot hole portion 335, an extending portion 339 extending in the first direction is formed on the cover surface portion 331. The sidewall portion 338 has a step portion 338a further extending in an extending direction thereof. An outside of the sidewall portion 338 is formed with an engagement portion 333, and an upper end of the engagement portion 333 extends to form an engaging portion 334 with a hook-shaped side surface in a side view. The second cover portion 33 may be fixed to the retaining portion 31 by engaging the engaging portion 334 with the protruding portion 312a of the retaining portion 31. In addition, at this time, the step portion 338a of the sidewall portion 338 abuts on the side portions 326 of the first cover portion 32, so that the first cover portion 32 is also fixed.

The first cover portion 32 and the second cover portion 33 are each rotatably mounted on the retaining portion 31, and the retaining portion 31, the first cover portion 32, and the second cover portion 33 are sequentially arranged from bottom to top. As shown in FIG. 12, when the first cover portion 32 is turned to the closed state, that is, the cover plate portion 321 is substantially parallel to the bottom surface portion 313 of the retaining portion 31, surfaces of the side portions 326 and the bottom surface portion 313 of the retaining portion 31 facing each other, an inner side surface of the second sidewall portion 312 of the retaining portion 31, and a surface of the pressed portion 322 of the first cover portion 32 facing the inner side surface constitute the first accommodating space 34 for accommodating one of the bus bars 20a and 20b. When the second cover portion 33 is also turned to the closed state, that is, when the cover surface portion 331 is substantially parallel to the cover plate portion 321 of the first cover portion 32, surfaces of the cover surface portion 331 of the second cover portion 33 and the side portions 326 of the first cover portion 32 facing each other, an inner side surface of the sidewall portion 338 of the second cover portion 33, and a surface of the extending portion 339 facing the inner side surface constitute the second accommodating space 35 for accommodating the other of the bus bars 20a and 20b.

According to the retaining member 30B of the third embodiment of the present disclosure, the upper end of the second sidewall portion 312 of the retaining portion 31 is formed with the two notches 310, and in the closed state, the side portions 326 of the first cover portion 32 are adapted and accommodated in the notches 310. This mating structure not only provides physical locking, but also improves the stability of the first cover portion, and can reduce the risk of accidental loosening due to vibration or mechanical stress.

In addition, the inner side surface of the sidewall portion 338 of the second cover portion 33 and the extending portion 336 constitute the second accommodating space 35, and displacement of the bus bars in the width direction is limited by the sidewall portion 332 and the extending portion 336 to ensure the stability of the bus bars. The structure effectively limits the unnecessary displacement of the bus bars in the width direction. Accordingly, potential damage caused by vibration or movement is reduced, and an additional guarantee is added to the stability and reliability of the whole battery pack device.

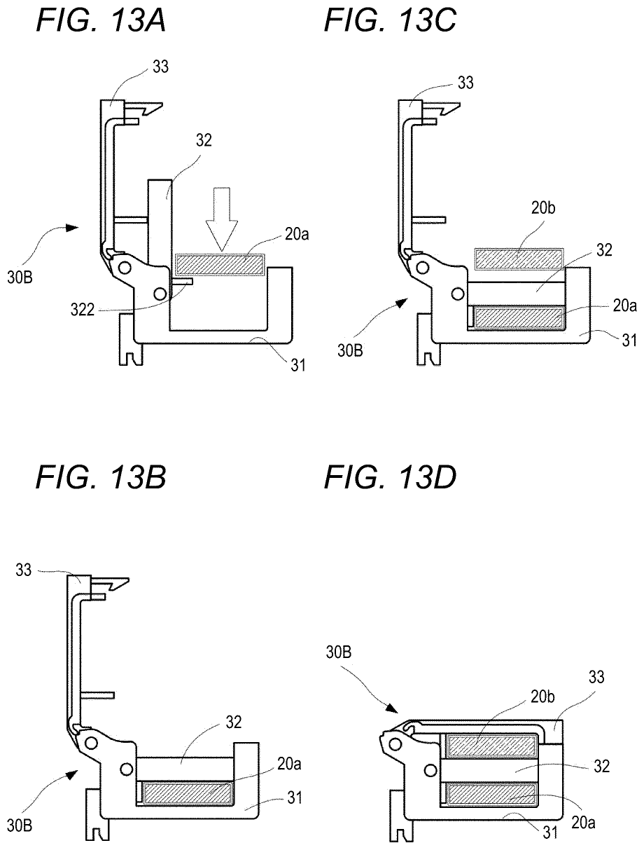

FIGS. 13A to 13D are schematic diagrams showing steps of installing the bus bars in the retaining member according to the third embodiment of the present disclosure. The steps of installing the bus bars 20a and 20b in the retaining member 30B are described in detail below with reference to FIGS. 13A to 13D. It should be noted that the following description is based on the installing of two bus bars 20a and 20b stacked up and down in the retaining member 30B as an example. For the installing of two bus bars 20a and 20b disposed side by side in the retaining member 30B, it is sufficient to rotate each member and the operating direction by 90 degrees in the following steps.

As shown in FIG. 13A, in the retaining member 30B, the first cover portion 32 and the second cover portion 33 are opened. At this point, the installer can start an installation process. The installer selects one bus bar (taking the bus bar 20a as an example) and presses it from above into the retaining member 30B, as indicated by an arrow. During this process, the bus bar 20a comes into contact with and pushes the pressed portion 322 of the first cover portion 32 when pressed downward. This action triggers the first cover portion 32 to rotate downward about an axis (rotating shafts 315) into the closed state, as shown in FIG. 13B. As the bus bar 20a continues moving until the bus bar 20a comes into contact with the bottom surface portion 313 of the retaining portion 31, the pressed portion 322 of the first cover portion 32 is pushed to be substantially perpendicular to the bottom surface portion 313 of the retaining portion 31. At this time, the first cover portion 32 is completely closed and covers the bus bar 20a, and the bus bar 20a is stably accommodated in the first accommodating space 34, thereby completing installation of the bus bar 20a.

Then, as shown in FIG. 13C, the installer places the second bus bar (bus bar 20b) from above into the second accommodating space 35 in a similar way. In the final step, as shown in FIG. 13D, the installer pushes the second cover portion 33 so as to rotate the second cover portion 33 to the closed state and presses the second cover portion 33 downward, so that the engaging portion 334 is engaged with the protruding portion 312a of the retaining portion 31, thereby fixing the second cover portion 33 to the retaining portion 31. At this time, the step portion 338a of the sidewall portion 338 abuts on the side portion 326 of the first cover portion 32, so that the first cover portion 32 is also fixed. In this manner, the installation of the bus bars 20a and 20b is completed.

Similar to the retaining members of the first and second embodiments, the retaining member 30B in the third embodiment of the present disclosure allows the two bus bars 20a and 20b to be fixed in the same retaining member, so that space can be efficiently utilized in the compact arrangement of the battery modules, and a space layout in the battery pack can be optimized. Moreover, by using the design of the pressed portion 322, the first cover portion 32 is automatically pushed to rotate and close when installing the first bus bar, the number of parts is reduced, and the operation steps of installing the bus bars are also simplified.

In addition, in the third embodiment of the present disclosure, the design of the retaining member 30B allows the installer to engage the retaining portion 31 and fix the first cover portion 32 and the second cover portion 33 together by pressing only the second cover portion 33 without pressing the first cover portion 32 and the second cover portion 33 in sequence. This design further simplifies the operation steps, improves installation efficiency, and makes it easier for the bus bars 20 to be fixed in the retaining member 30B. Moreover, since the first cover portion 32 and the second cover portion 33 are opened toward the same side and an opening degree is relatively large, the operation space is larger and it is easier to visually recognize the bus bars 20 when the bus bars 20 are installed.

In the closed state, the side portions 326 of the first cover portion 32 are adapted and accommodated in the notches 310, and this mating structure not only provides physical locking, but also improves the stability of the first cover portion, and can reduce the risk of accidental loosening due to vibration or mechanical stress.

In addition, the inner side surface of the sidewall portion 338 of the second cover portion 33 and the extending portion 336 constitute the second accommodating space 35, and the sidewall portion 332 and the extending portion 336 limit displacement of the bus bars in the width direction and thus effectively limit the unnecessary displacement of the bus bars in the width direction. Accordingly, potential damage caused by vibration or movement is reduced, and an additional guarantee is added to the stability and reliability of the whole battery pack device.

The present disclosure is not limited to the above-described embodiments, and modifications, improvements, or the like can be made as appropriate. For example, in the above-described embodiments, the two bus bars stacked up and down are fixed by one retaining member, and the two bus bars disposed side by side are fixed by three retaining members, but the present disclosure is not limited thereto. The number of retaining members may be flexibly increased or decreased according to the size of an installation space, the number of bus bars and the complexity of electrical connection. For example, for electronic devices or battery modules requiring high-density wiring, a more compact retaining member layout scheme may be designed to optimize space usage efficiency. In addition, it is also possible to consider using a retaining member in a mountain shape (or other geometric shapes) to fix the bus bars disposed side by side.

In addition, in the above-described embodiments, the rotating shafts are provided on the retaining portion in the retaining member, and the pivot holes cooperating therewith are disposed on the first and second cover portions, respectively. The present disclosure may also adopt a reverse configuration, that is, a pivot hole is provided on the retaining portion, and the rotating shafts are disposed on the first and second cover portions, respectively. The adjustability of this design provides greater flexibility for assembly and maintenance of the product, while also optimizing the design of a rotating mechanism according to specific application requirements.

In addition, the fixing of the first cover portion and the second cover portion to the retaining portion is not limited to the engagement mode of the engaging portion and the slot, and other fixing mechanisms may also be adopted, such as using structures such as protruding stripes and quick locks.

According to the battery device in the present disclosure, the two bus bars can be fixed by using one retaining member, the requirement of two or more independent retaining members in the past is eliminated, the number of parts is reduced, and operation steps of installing the bus bars are simplified. Moreover, the space can be efficiently utilized in the compact arrangement of the battery modules, the space layout in the battery device is optimized, a more efficient, compact and economical battery device for an electric vehicle can be manufactured, and important support is provided for popularization and development of the electric vehicle.

In addition, the present disclosure includes at least the following items, corresponding components or the like in the above-described embodiments are indicated in brackets, but the present disclosure is not limited thereto.

### Scheme 1

A battery device for an electric vehicle, including:
a plurality of battery modules (battery modules 11); and
a housing (housing 12) configured to accommodate the plurality of battery modules, wherein
the housing is configured to accommodate a pair of strip-shaped bus bars (bus bars 20a and 20b) and a retaining member (retaining member 30) retaining the pair of bus bars,
the retaining member includes
   a retaining portion (retaining portion 31) with one side open and having a U-shaped cross section, and
   a first cover portion (first cover portion 32) and a second cover portion (second cover portion 33) that are rotatably disposed on the retaining portion,
a first bus bar of the pair of bus bars is accommodated between the retaining portion and the first cover portion,
a second bus bar of the pair of bus bars is accommodated between the first cover portion and the second cover portion, and
a pressed portion (pressed portion 322) is formed on the first cover portion, and is formed to be pressed and cause the first cover portion to rotate when the first bus bar is placed between the retaining portion and the first cover portion.

By adopting the battery device of scheme 1, the two bus bars can be fixed by using one retaining member, thereby eliminating the need for two or more independent retaining members in the past. Moreover, by adopting the design of the pressed portion, the first cover portion is automatically pushed to rotate and close when installing the first bus bar. This design not only reduces the number of parts, but also simplifies the operation steps of installing the bus bars. In this way, the present disclosure not only improves assembly efficiency, but also enhances overall structural stability and a space utilization rate of the battery pack.

### Scheme 2

In the battery device according to scheme 1,
the retaining member includes a first rotating shaft (rotating shaft 315) configured to rotate the first cover portion and a second rotating shaft (rotating shaft 316) configured to rotate the second cover portion,
the retaining portion has facing sidewalls (first sidewall portion 311 and second sidewall portion 312),
the first rotating shaft is disposed on one of the facing sidewalls (second sidewall portion 312),
the second rotating shaft is disposed on the other of the facing sidewalls (the second sidewall portion 312),
a first engagement portion (engagement portion 324) engaged with the retaining portion is formed on the first cover portion, and
a second engagement portion (engagement portion 333) engaged with the retaining portion is formed on the second cover portion.

By adopting the battery device of scheme 2, the first cover portion and the second cover portion are respectively disposed on different sidewall portions, and the first cover portion is automatically pushed to rotate around the first rotating shaft and close when installing the first bus bar. At this time, the first engagement portion can be operated to fix the first cover portion to the retaining portion, thereby simplifying the operation steps of installing the bus bars.

### Scheme 3

In the battery device according to scheme 1,
the retaining member (retaining member 30A) includes a first rotating shaft (rotating shaft 315) configured to rotate the first cover portion and a second rotating shaft (rotating shaft 316) configured to rotate the second cover portion,
the retaining portion has facing sidewalls (first sidewall portion 311 and second sidewall portion 312),
both the first rotating shaft and the second rotating shaft are provided on one of the facing sidewalls (first sidewall portion 311),
the first cover portion has a contact wall (contact wall 323) configured to be in contact with the second cover portion, and
an engagement portion (engagement portion 333) is formed on the second cover portion, and the engagement portion is formed to be engaged with the retaining portion in a state in which the second cover portion is in contact with the contact wall.

By adopting the battery device of scheme 3, the engagement portion is formed to be engaged with the retaining portion in the state in which the second cover portion is in contact with the contact wall. This design allows an installer to engage the retaining portion and fix the first cover portion and the second cover portion together by pressing only the second cover portion without pressing the first cover portion and the second cover portion in sequence, operation steps are further simplified, and installation efficiency is improved.

### Scheme 4

In the battery device according to scheme 3,
a groove portion (groove 337) configured to accommodate a portion of the second bus bar is formed in the second cover portion, and
the second bus bar is retained between one side surface of the contact wall of the first cover portion and one side surface of the groove portion of the second cover portion.

By adopting the battery device of scheme 4, the second bus bar is retained between the contact wall of the first cover portion and the groove portion of the second cover portion, the groove portion and the contact wall limit displacement of the bus bars in the width direction and thus effectively limit the unnecessary displacement of the bus bars. Accordingly, the potential damage caused by vibration or movement is reduced, and an additional guarantee is added to the stability and reliability of the whole battery pack device.

### Scheme 5

In the battery device according to scheme 1,
the retaining member (retaining member 30B) includes a first rotating shaft (rotating shaft 315) configured to rotate the first cover portion and a second rotating shaft (rotating shaft 316) configured to rotate the second cover portion,
the retaining portion has facing sidewalls (first sidewall portion 311 and second sidewall portion 312),
both the first rotating shaft and the second rotating shaft are provided on one of the facing sidewalls (first sidewall portion 311),
a contact portion configured to be in contact with the second cover portion is provided on the other of the facing sidewalls,
the contact portion is allowed to be inserted by a part of the first cover portion, and
an engagement portion (protruding portion 312a) is formed on the contact portion, and the engagement portion is formed to be engaged with the second cover portion in a state in which the contact portion is in contact with the second cover portion.

With the battery device of scheme 5, a contact portion configured to be in contact with the second cover portion is provided on the other of the facing sidewalls, the contact portion is allowed to be inserted by the part of the first cover portion, and the engagement portion is formed to be engaged with the second cover portion in a state in which the contact portion is in contact with the second cover portion. The engagement structure not only provides physical locking, but also improves stability of the first cover portion, and can reduce a risk of accidental loosening due to vibration or mechanical stress.

### Scheme 6

In the battery device according to scheme 5,
the second cover portion is provided with a protruding portion (extending portion 339) protruding from an inner side surface, and
the second bus bar is retained between one side surface of the contact portion and one side surface of the protruding portion.

By adopting the battery device of scheme 6, the contact portion and the protruding portion form a space for accommodating the second bus bar, limit the displacement of the second bus bar and thus effectively limit the unnecessary displacement of the bus bars. Accordingly, the potential damage caused by vibration or movement is reduced, and the additional guarantee is added to the stability and reliability of the whole battery pack device.

### Scheme 7

In the battery device according to any one of schemes 2, 3 and 5,
the first bus bar is retained between the pressed portion of the first cover portion and a sidewall of the facing sidewalls of the retaining portion facing the pressed portion.

By adopting the battery device of scheme 7, the pressed portion and the sidewall of the retaining portion facing the pressed portion form a space for accommodating the second bus bar, limit the displacement of the second bus bar, and thus effectively limit the unnecessary displacement of the bus bars. Accordingly, the potential damage caused by vibration or movement is reduced, and the additional guarantee is added to the stability and reliability of the whole battery pack device.

### Scheme 8

In the battery device according to scheme 1,
the pair of bus bars is retained by the retaining member in a state in which thickness directions face the same direction.

By adopting the battery device of scheme 8, the pair of bus bars is retained by the retaining member in the state in which the thickness directions face the same direction, that is, the pair of bus bars is allowed to be stacked up and down or left and right side by side, a space can be efficiently utilized in the compact arrangement of the battery modules, and a space layout in the battery pack can be optimized.

### Scheme 9

A method for assembling bus bars, the bus bars being assembled in a battery device using a retaining member, the battery device being a battery device for an electric vehicle and including a plurality of battery modules (battery modules 11), and a housing (housing 12) configured to accommodate the plurality of battery modules, the pair of strip-shaped bus bars (bus bars 20a and 20b) and the retaining member (retaining member 30) retaining the pair of bus bars being accommodated in the housing, the retaining member including a retaining portion (retaining portion 31) with one side open and having a U-shaped cross section, and a first cover portion (first cover portion 32) and a second cover portion (second cover portion 33) rotatably disposed on the retaining portion, and a pressed portion (pressed portion 322) being formed on the first cover portion, the method comprising:
pressing a first bus bar (bus bar 20a) of the pair of bus bars toward the pressed portion to rotate the first cover portion, and accommodating the first bus bar between the retaining portion and the first cover portion;
disposing a second bus bar (bus bar 20b) of the pair of bus bars on the rotated first cover portion; and
rotating the second cover portion to accommodate the second bus bar between the first cover portion and the second cover portion.

By adopting the method for assembling bus bars of scheme 9, the two bus bars can be fixed by using one retaining member in the battery device, thereby eliminating the need for two or more independent retaining members in the past. Further, by adopting the design of the pressed portion, the first cover portion is automatically pushed to rotate and close when installing the first bus bar, and the operation steps of installing the bus bars are simplified. Not only is assembly efficiency improved, but also overall structural stability and a space utilization rate of the battery pack are enhanced.

### Scheme 10

In the method for assembling bus bars according to scheme 9,
after the first bus bar is accommodated between the retaining portion and the first cover portion, a first engagement portion (engagement portion 324) formed on the first cover portion is engaged with the retaining portion, and
after the second bus bar is accommodated between the first cover portion and the second cover portion, a second engagement portion (engagement portion 333) formed on the second cover portion is engaged with the retaining portion.

By adopting the bus bar assembly method of scheme 10, the first cover portion is automatically pushed to rotate and close when installing the first bus bar. At this time, the first engagement portion can be operated to fix the first cover portion to the retaining portion, then the second bus bar is installed, and finally, the second engagement portion is operated to fix the second cover portion to the retaining portion, thereby simplifying the operation steps of installing the bus bars.

### Scheme 11

In the method for assembling bus bars according to scheme 9,
after the second bus bar is accommodated between the first cover portion and the second cover portion, an engagement portion (engagement portion 333) formed on the second cover portion is engaged with the retaining portion in a state in which the second cover portion is in contact with a contact wall (contact wall 323) of the first cover portion.

By adopting the bus bar assembly method of scheme 11, the retaining portion is engaged and the first cover portion and the second cover portion are fixed together by pressing only the second cover portion without pressing the first cover portion and the second cover portion in sequence, operation steps are further simplified, and installation efficiency is improved.

1. A battery device for an electric vehicle, comprising:
a plurality of battery modules; and
a housing configured to accommodate the plurality of battery modules, wherein
the housing configured to accommodate a pair of strip-shaped bus bars and a retaining member retaining the pair of bus bars,
the retaining member includes
a retaining portion with one side open and having a U-shaped cross section, and
a first cover portion and a second cover portion that are rotatably disposed on the retaining portion,
a first bus bar of the pair of bus bars is accommodated between the retaining portion and the first cover portion,
a second bus bar of the pair of bus bars is accommodated between the first cover portion and the second cover portion, and
a pressed portion is formed on the first cover portion, and is formed to be pressed and cause the first cover portion to rotate when the first bus bar is placed between the retaining portion and the first cover portion.

2. The battery device according to claim 1, wherein
the retaining member includes a first rotating shaft configured to rotate the first cover portion and a second rotating shaft configured to rotate the second cover portion,
the retaining portion has facing sidewalls,
the first rotating shaft is disposed on one of the facing sidewalls,
the second rotating shaft is disposed on the other of the facing sidewalls,
a first engagement portion engaged with the retaining portion is formed on the first cover portion, and
a second engagement portion engaged with the retaining portion is formed on the second cover portion.

3. The battery device according to claim 1,
the retaining member includes a first rotating shaft configured to rotate the first cover portion and a second rotating shaft configured to rotate the second cover portion,
the retaining portion has facing sidewalls,
both the first rotating shaft and the second rotating shaft are provided on one of the facing sidewalls,
the first cover portion has a contact wall configured to be in contact with the second cover portion, and
an engagement portion is formed on the second cover portion, and the engagement portion is formed to be engaged with the retaining portion in a state in which the second cover portion is in contact with the contact wall.

4. The battery device according to claim 3,
a groove portion configured to accommodate a portion of the second bus bar is formed in the second cover portion, and
the second bus bar is retained between one side surface of the contact wall of the first cover portion and one side surface of the groove portion of the second cover portion.

5. The battery device according to claim 1, wherein
the retaining member includes a first rotating shaft configured to rotate the first cover portion and a second rotating shaft configured to rotate the second cover portion,
the retaining portion has facing sidewalls,
both the first rotating shaft and the second rotating shaft are provided on one of the facing sidewalls,
a contact portion configured to be in contact with the second cover portion is provided on the other of the facing sidewalls,
the contact portion is allowed to be inserted by a part of the first cover portion, and
an engagement portion is formed on the contact portion, and the engagement portion is formed to be engaged with the second cover portion in a state in which the contact portion is in contact with the second cover portion.

6. The battery device according to claim 5, wherein
the second cover portion is provided with a protruding portion protruding from an inner side surface, and
the second bus bar is retained between one side surface of the contact portion and one side surface of the protruding portion.

7. The battery device according to claim 2, wherein
the first bus bar is retained between the pressed portion of the first cover portion and a sidewall of the facing sidewalls of the retaining portion facing the pressed portion.

8. The battery device according to claim 1, wherein
the pair of bus bars is retained by the retaining member in a state in thickness directions face the same direction.

9. A method for assembling bus bars in a battery device for an electric vehicle using a retaining member, wherein
the battery device includes a plurality of battery modules and a housing configured to accommodate the plurality of battery modules,
the housing is configured to accommodate the pair of strip-shaped bus bars and the retaining member retaining the pair of bus bars,
the retaining member includes a retaining portion with one side open and having a U-shaped cross section, and a first cover portion and a second cover portion that are rotatably disposed on the retaining portion,
a pressed portion is formed on the first cover portion, and
the method comprises:
pressing a first bus bar of the pair of bus bars toward the pressed portion to rotate the first cover portion, and accommodating the first bus bar between the retaining portion and the first cover portion;
disposing a second bus bar of the pair of bus bars on the rotated first cover portion; and
rotating the second cover portion to accommodate the second bus bar between the first cover portion and the second cover portion.

10. The method for assembling bus bars according to claim 9, wherein
after the first bus bar is accommodated between the retaining portion and the first cover portion, a first engagement portion formed on the first cover portion is engaged with the retaining portion, and
after the second bus bar is accommodated between the first cover portion and the second cover portion, a second engagement portion formed on the second cover portion is engaged with the retaining portion.

11. The method for assembling bus bars according to claim 9, wherein
after the second bus bar is accommodated between the first cover portion and the second cover portion, an engagement portion formed on the second cover portion is engaged with the retaining portion in a state in which the second cover portion is in contact with a contact wall of the first cover portion.
